(19) United States
(12) Patent Application Publication
(10) Pub. No.: US 2010/0332256 A1
(43) Pub. Date: Dec. 30, 2010

(54) Medical Data Indexing System and Method

(75) Inventors: Matthew Richard Schwartz, Oconomowoc, WI (US); Richard Coe, Sussex, WI (US)

Correspondence Address: GE HEALTHCARE;c/o FLETCHER YODER, PC, P.O. BOX 692289, HOUSTON, TX, 77269-2289, US

(73) Assignee: General Electric Company, Schenectady, NY (US)

(21) Appl. No.: 12/495,186

(22) Filed: Jun. 30, 2009

(51) Int. Cl. G06Q 50/00

(52) U.S. Cl. 705/3; 705/2

(57) ABSTRACT

A data processing technique is provided. In one embodiment, a method includes crawling a network via a computing device to access patient data from a plurality of medical resources coupled to the network. The medical resources may include various imaging systems, computers, databases, patient monitors, and other medical devices and systems. The method may also include populating a searchable index of patient data accessed from at least a first medical resource of the plurality of medical resources, and storing the searchable index in a memory device to facilitate user-searching of the patient data via the searchable index. In one embodiment, the patient data includes either or both of DICOM data and HL7 data. Additional methods, systems, and devices are also disclosed.

### BACKGROUND

The present disclosure relates generally to the field of medical data processing and, more specifically, to techniques for electronically indexing and searching medical data.

Healthcare facilities, such as medical practitioner offices, clinics, and hospitals, often include various electronic devices and systems for acquiring and storing patient data and other medical information. For instance, a hospital may include various imaging systems, such as X-ray systems, CT systems, MR systems, and PET systems, as well as various computer workstations, servers, and databases. While the hospital may include various networks and information technology infrastructure to facilitate communication between the numerous disparate devices and systems, patient data is typically distributed over these disparate systems.

For example, data associated with a single particular patient may include image data stored at various separate imaging systems or archives (e.g., CT scans and MR scans), a set of lab results on a computer within the hospital, additional lab results stored on one or more other computers, patient medical history stored within yet another computer, and additional patient information stored in still yet another computer. Additionally, in some instances patient information is stored in computers and systems that are distributed over multiple facilities, such as a network of hospitals, clinics, and other medical facilities. While it may be desirable to find particular items of data within a healthcare network, such tasks are typically time-consuming and inefficient given the vast amount of data and array of storage locations to be searched.

### BRIEF DESCRIPTION

Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

Certain embodiments of the present invention may generally relate to techniques for indexing medical data in a networked healthcare system, such as a network of components within a hospital or other healthcare facility, or a network of components distributed over multiple facilities near or remote from one another. In one embodiment, a network medical data crawler may search the network and index DICOM data and HL7 data stored within the various components of the networked system. A user may then input search terms via a user interface, and the indexed DICOM and HL7 data may be searched based on the search terms.

Various refinements of the features noted above may exist in relation to various aspects of the present invention. Further features may also be incorporated in these various aspects as well. These refinements and additional features may exist individually or in any combination. For instance, various features discussed below in relation to one or more of the illustrated embodiments may be incorporated into any of the above-described aspects of the present invention alone or in any combination. Again, the brief summary presented above is intended only to familiarize the reader with certain aspects and contexts of the present invention without limitation to the claimed subject matter.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an exemplary processor-based system in accordance with one embodiment;

FIG. 2 is a block diagram generally depicting a network of medical systems including medical data that may be indexed and searched in accordance with one embodiment;

FIG. 3 is a flowchart of a method for indexing medical data included in a network of medical systems in accordance with one embodiment; and

FIG. 4 is a flowchart of a method facilitating user access to indexed medical data in accordance with one embodiment.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Moreover, while the term “exemplary” may be used herein in connection to certain examples of aspects or embodiments of the presently disclosed technique, it will be appreciated that these examples are illustrative in nature and that the term “exemplary” is not used herein to denote any preference or requirement with respect to a disclosed aspect or embodiment.

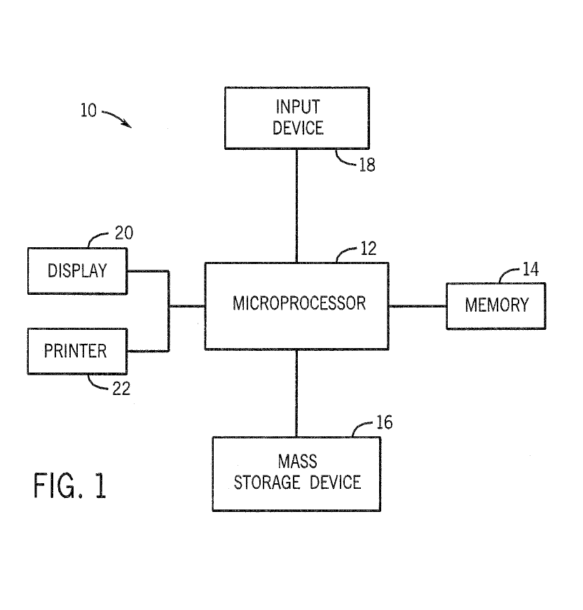

Turning now to the drawings, and referring first to FIG. 1, an exemplary processor-based system 10 for use in conjunction with the present technique is depicted. In one embodiment, the exemplary processor-based system 10 is a general-purpose computer, such as a personal computer, configured to run a variety of software, including software implementing all or part of the present technique. Alternatively, in other embodiments, the processor-based system 10 may include, among other things, a mainframe computer, a distributed computing system, or an application-specific computer or workstation configured to implement all or part of the present technique based on specialized software and/or hardware provided as part of the system. Further, the processor-based system 10 may include either a single processor or a plurality of processors to facilitate implementation of the presently disclosed functionality.

The exemplary processor-based system 10 may include a microcontroller or microprocessor 12, such as a central processing unit (CPU), which executes various routines and processing functions of the system 10. For example, the microprocessor 12 may execute various operating system instructions as well as software routines configured to effect certain processes and stored in or provided by a manufacture including a computer-readable storage medium, such as a memory 14 (e.g., a random access memory (RAM) of a personal computer) or one or more mass storage devices 16 (e.g., an internal or external hard drive, a solid-state storage device, CD-ROM, DVD, or other storage device). It is noted that such software may be fully encoded on a single computer-readable storage medium, or may be distributed over multiple computer-readable storage media (e.g., multiple disks each containing a portion of the software and collectively including all of the software). In addition, the microprocessor 12 processes data provided as inputs for various routines or software programs, such as data provided as part of the present technique in computer-based implementations.

Such data may be stored in, or provided by, the memory 14 or mass storage device 16. Alternatively, such data may be provided to the microprocessor 12 via one or more input devices 18. The input devices 18 may include manual input devices, such as a keyboard, a mouse, or the like. In addition, the input devices 18 may include a network device, such as a wired or wireless Ethernet card, a wireless network adapter, or any of various ports or devices configured to facilitate communication with other devices via any suitable communications network, such as a local area network or a wide area network (e.g., the Internet). Through such a network device, the system 10 may exchange data and communicate with other networked electronic systems, whether proximate to or remote from the system 10. It will be appreciated that such a communication network may include various components that facilitate communication, including switches, routers, servers or other computers, network adapters, communications cables, and so forth.

Results generated by the microprocessor 12, such as the results obtained by processing data in accordance with one or more stored routines, may be provided to an operator via one or more output devices, such as a display 20 and/or a printer 22. Based on the displayed or printed output, an operator may request additional or alternative processing or provide additional or alternative data, such as via the input device 18. As will be appreciated by those of ordinary skill in the art, communication between the various components of the processor-based system 10 may typically be accomplished via a chipset and one or more busses or interconnects which electrically connect the components of the system 10. Notably, in certain embodiments of the present technique, the exemplary processor-based system 10 may be configured to enable indexing of healthcare information stored in various components of a networked system and searching of such indexed information by a user, as discussed in greater detail below.

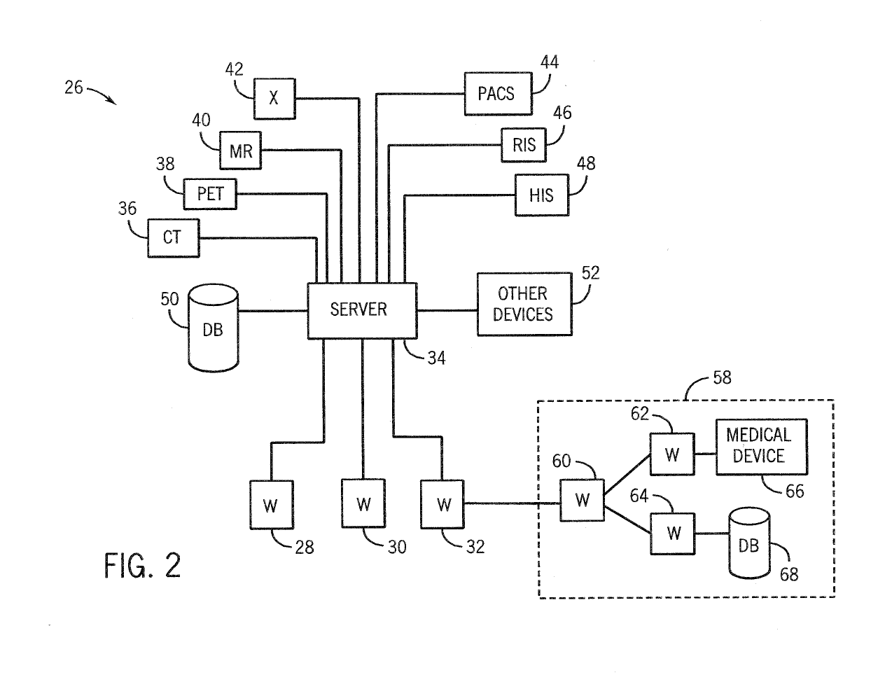

By way of example, a networked healthcare system 26 is depicted in FIG. 2 in accordance with one embodiment. In this presently illustrated embodiment, the system 26 includes one or more computers, such as workstations 28, 30, and 32, and a server 34, that may be communicatively coupled to one another and to other components via one or more networks. Any or all of these computers, as well as the other components of the healthcare system 26 discussed below, may include the components of the processor-based system 10 illustrated in FIG. 1, although it is noted that, in other embodiments, one or more of these computers (or other components of system 26) may include various components or systems different than, or in addition to, those illustrated in FIG. 1. Additionally, the network enabling communication between the computers and other components of the system 26 may include one or more of a local area network (LAN) or a wide area network (WAN) (e.g., the Internet), as well as various other components that facilitate communication, as generally noted above. While the various components of the networked healthcare system 26 may be provided at a common location or facility (e.g., within a hospital), it is noted that such components may instead be distributed at different locations, such as at various healthcare facilities remote from one another.

In one embodiment, other components of the networked healthcare system 26 include medical imaging devices of one or more modalities, such as a computed tomography (CT) system 36, a positron emission tomography (PET) system 38, a magnetic resonance (MR) system 40, an X-ray system 42, or the like. It should be appreciated, however, that the present teachings may also or instead be used in consort with other imaging system modalities, as well as patient monitors, diagnostic devices, other medical resources, or some combination of these devices and systems. Such other medical resources may include, but are not limited to, one or more picture archiving and communication systems (PACS) 44, radiological information systems (RIS) 46, hospital information systems (HIS) 48, other databases 50 and devices 52, and so forth. While various components of the system 26 are generally depicted as communicatively coupled to the server 34, it is noted that such components may be coupled in any desirable fashion, and need not be commonly coupled to any single device or component.

In various embodiments, the present techniques allow for the indexing of medical information, such as patient images and electronic medical records, in the networked healthcare system 26. In one embodiment, a network crawler application may be stored on one or more memory devices within the system 26 and may be executed by a processor to crawl the networked healthcare system 26 and discover medical data. Particularly, the network crawler application may discover medical data stored in or provided by various components of the system 26, and may add such information to an index table stored within the system 26, such as within one or more of the workstations 28, 30, and 32, the server 34, the database 50, or some other component of the system 26.

For example, in one embodiment, the server 34 may include the network crawler application, which may be executed to browse the network system 26 in a methodical manner to locate and index information from components within the system 26 that are known by the server 34. For instance, in various embodiments, the network crawler application may locate and index DICOM information stored on or generated by various components of the healthcare system 26, such as the CT system 36, the PET system 38, the MR system 40, and the X-ray system 42, as well as the PACS 44. In another embodiment, the network crawler application may also or instead be configured to locate and index HL7 information resident in the system 26, such as within the RIS system 46, the HIS system 48, or the like. In some embodiments, the server 34 may be able to access each of the other components of the system 26, in which case the network crawler application on the server 34 may be capable of locating and indexing all of the desired information in the system 26.

In other embodiments, however, the server 34 may not be aware of, or be able to access, at least some of the additional components of the system 26. For instance, in the embodiment illustrated in FIG. 2, a group 58 of components, such as a workgroup, may be configured to communicate only with the workstation 32, and may not be accessible to the server 34 (e.g., group 58 may be behind a firewall and undetectable or inaccessible by the server 34). The group 58 of components may include additional workstations 60, 62, 64, additional medical device(s) 66, a database 68, or any other desired combination of components. Although the components of the group 58 may not be accessible to the server 34, in one embodiment the networked healthcare system 26 supports a hybrid peer-to-peer architecture, in which information within the components of the group 58 may be indexed separately, such as by a network crawling application of the workstation 32 or the workstation 60. This additionally indexed information may be added to the first index to create a master index, may be provided to the server 34 and stored as a separate index from that directly constructed by the server 34, or may simply be available for searching at the local device (e.g., workstation 32 or 60) in response to a user search query. Further, in one embodiment, various components of healthcare system 26, such as workstation 32, may include a medical data network crawler and act as a DICOM edge appliance for the system 26.

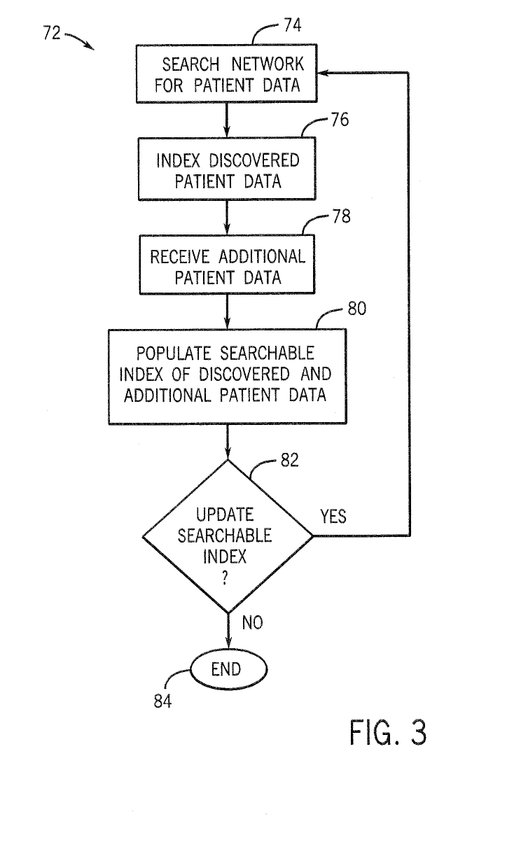

By way of further example, an exemplary method 72 for creating a searchable index of medical data is generally depicted in FIG. 3 in accordance with one embodiment. The method 72 may include crawling or searching the network for patient data and indexing discovered patient data, as generally depicted by blocks 74 and 76. In one embodiment, such searching is performed through analysis of data stored in accordance with at least one of DICOM or HL7 data protocols. Additional patient data may be received, as generally depicted in block 78, and the discovered patient data and received additional patient data may be used to populate a searchable index, as generally depicted in block 80. The searchable index may be updated in actual or near real-time, on a periodic basis (e.g., every five minutes, every hour, every six hours, every day, or any other suitable period), or may be automatically updated upon input of new data to the networked healthcare system 26. Such updating may occur prior to the end 84 of the method 72.

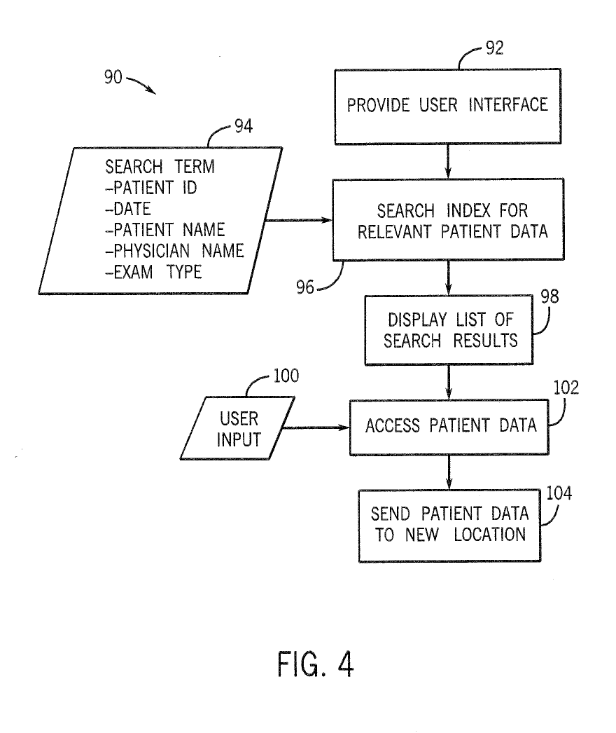

With respect to searching the index, a method 90 of performing such searching is provided in FIG. 4 in accordance with one embodiment. Particularly, the method 90 may include providing a user interface to a user, as generally indicated by reference numeral 92. For instance, the user interface may be provided as a text input field, a window in a graphical user interface, or some other suitable interface that facilitates user interaction with various capabilities of the system 26. The user interface may include a web interface, and may be a secure interface supporting various user authentication, authorization, and auditing protocols (e.g., Lightweight Directory Access Protocol (LDAP), Kerberos protocol, SSL/TLS and Security Assertion Markup language (SAML)). By way of further example, the user interface may allow a user to enter a search term 94 for searching the indexed patient data. The indexed patient data may be contained within a single index or table, such as the master index noted above, or may be contained in multiple indices stored within either a single device (e.g., server 34) or distributed over multiple devices (e.g., some combination of the components of system 26). Although any desirable search terms may be used in various embodiments, non-limiting examples of such search terms may include a patient name, a physician name, a type of exam, a date, some other patient identification information, and so forth.

Once the user provides one or more search terms 94, software embodying the present techniques may be executed to search the index for relevant patient data, as generally depicted in block 96, and may display a list of search results, as depicted in block 98. The displayed list of search results may be provided in any suitable format, including a visual display in a graphical user interface of one of the components (e.g., a workstation), a printed list of search results, or the like. The user may also enter additional search terms 94 to refine the results of the search. It is noted that the list of search results based on a query for a particular patient name may generally represent a virtual electronic medical record for that patient, and may include various data obtained from disparate systems. For instance, in one embodiment, the search results may include data on patient history, physicals, lab reports, scheduled procedures, patient images, and the like. Such a virtual electronic medical record could then be stored locally on an internal memory of a computing device, or may be stored on removable media, such as a USB drive, a memory card, or an optical disc.

Additionally, the index search may employ various algorithms (e.g., fuzzy logic and/or data correlation routines) in matching certain search terms (e.g., names and identifiers) to data contained within the index, and may provide assurance scores or other relevance indicators to the user regarding the strength of the match between a search term and data returned by the search. For instance, the searching of the index may account for common misspellings in names to be searched. Still further, in one embodiment such searching and assurance scores may include enhanced matching and correlation of data based on various patient characteristics (e.g., weight, height, age, data of birth, etc.), the type of exams in a sequence of exams, dates of exams, the treating physician, the diagnostic technician, and the like.

In embodiments in which the list is displayed to a user electronically, a user may provide an input 100 to select or manipulate one or more items of information listed in the search results. For instance, the user may interact with the system to access patient data and to send patient data from its location on one or more of the components of the system 26 to a new location, such as generally depicted in blocks 102 and 104. For example, in one embodiment, a user of the workstation 30 may search for data relevant to a particular patient. A list of information relevant to that patient may be displayed (block 98) and may include, for example, medical images generated by one of the imaging modalities of the system 26, or stored within the PACS 44. Additionally, relevant information may also include various lab results, electronic medical records, or other informational items. A user of the workstation 30 may then view the data or may send data from one location in the network system 26 to another location via DICOM or HL7, such as to another department or user workstation.

A technical effect of the systems and methods described herein may include, among other things, enabling efficient electronic searching of medical data by a user via accessing and indexing such medical data across multiple components in a networked medical system. While only certain features of the invention have been illustrated and described herein, many modifications and changes will occur to those skilled in the art. It is, therefore, to be understood that the appended claims are intended to cover all such modifications and changes as fall within the true spirit of the invention.

1. A system comprising:
a first processor-based device configured to access DICOM data from at least one medical resource known to the first processor-based device via a network and to create a master index that includes information regarding the DICOM data accessed by the first processor-based device; and
a second processor-based device configured to access DICOM data from at least one additional medical resource known to the second processor-based device but unknown to the first processor-based device via the network and to create an additional index of the DICOM data accessed by the second processor-based device;
wherein the second processor-based device is configured to communicate the additional index to the first processor-based device, and the first processor-based device is configured to include information from the additional index in the master index such that the master index created by the first processor-based device includes information regarding the DICOM data accessed from the at least one additional medical resource.

2. The system of claim 1, wherein the first and the second processor-based devices are configured to access HL7 data.

3. The system of claim 1, wherein the first processor-based device is configured to receive a user query, to search the master index for data relevant to the user query, and to communicate results of the search to the user.

4. The system of claim 3, wherein the first processor-based device is configured to communicate the data relevant to the user query upon a request by the user.

5. The system of claim 1, wherein the at least one medical resource comprises at least one of the second processor-based device or a medical imaging system.

6. A method comprising:
crawling a network via a computing device to access patient data from a plurality of medical resources coupled to the network;
populating a searchable index of patient data accessed from at least a first medical resource of the plurality of medical resources; and
storing the searchable index in a memory device to facilitate user-searching of the patient data via the searchable index.

7. The method of claim 6, wherein populating the searchable index includes:
receiving at the computing device a separate index of patient data from the first medical resource, the separate index based at least in part on information accessed from a second medical resource independent of the computing device; and
including information from the separate index within the searchable index such that the searchable index includes indexed patient data obtained from the second medical resource independent of the computing device.

8. The method of claim 7, wherein the separate index of patient data is generated by the first medical resource.

9. The method of claim 7, wherein the second medical resource is unknown to the computing device upon commencement of the crawling of the network.

10. The method of claim 6, comprising receiving a search parameter from a user and searching the indexed patient data based at least in part on the search parameter.

11. The method of claim 10, comprising displaying results of the search of the indexed patient data in a graphical user interface.

12. The method of claim 11, comprising receiving a user input indicative of desired information selected by the user from the displayed search results, and initiating communication of the desired information to the user in response to the user input.

13. The method of claim 11, wherein the search parameter includes a patient identifier and the displayed search results include at least one relevance indicator based at least in part on a patient data correlation routine.

14. The method of claim 13, wherein the patient data correlation routine includes comparing a first patient data item to a second patient data item to determine a correlation between attributes of the first and second patient data items.

15. The method of claim 14, wherein the attributes include patient name or other identifier, patient height, patient weight, patient date of birth, patient date of exam, treating physician, diagnostic technician, or type of exam.

16. The method of claim 6, wherein the searchable index includes at least one of indexed image data accessed from a DICOM-based imaging system or indexed patient data accessed from an HL7 device.

17. A manufacture comprising:
a computer-readable storage medium having application instructions encoded thereon, wherein the application instructions are configured to effect, upon execution:
crawling a network via a computing device to create a searchable index of patient data accessed from at least a first medical resource coupled to the network, wherein creating the searchable index includes receiving at the computing device a separate index of patient data from the first medical resource, the separate index based at least in part on information accessed from a second medical resource independent of the computing device, and including information from the separate index within the searchable index such that the searchable index includes indexed patient data obtained from the second medical resource independent of the computing device; and
storing the searchable index to facilitate user-searching of the patient data.

18. The manufacture of claim 17, wherein the application instructions are configured to effect, upon execution, searching of the searchable index in response to a user-provided search parameter, and communicating results of the search to the user.

19. The manufacture of claim 18, wherein the application instructions are configured to effect, upon execution, communicating patient data to the user based on a user request based at least in part on the results of the search.

20. The manufacture of claim 17, wherein the computer-readable storage medium comprises a plurality of computer-readable storage media at least collectively having the executable instructions stored thereon.
